(19) United States
(12) Patent Application Publication
(10) Pub. No.: US 2016/0063406 A1
(43) Pub. Date: Mar. 3, 2016

(54) BUSINESS DEVELOPMENT SYSTEM AND METHOD

(71) Applicant: Calfee, Halter & Griswold LLP, Cleveland, OH (US)

(72) Inventors: Nenad Pejic, Broadview Hts., OH (US); Christopher S. Williams, Westlake, OH (US); Chad S. DeHart, Avon, OH (US); Tammy L. Loukas, Cleveland, OH (US); Mark A. Watson, Avon, OH (US)

(21) Appl. No.: 14/794,337

(22) Filed: Jul. 8, 2015

Related U.S. Application Data
(60) Provisional application No. 62/021,943, filed on Jul. 8, 2014.

(51) Int. Cl. G06Q 10/06

(52) U.S. Cl. CPC G06Q 10/0637

(57) ABSTRACT

Systems and methods for managing business development activity within an organization include a server reading and storing business development data and user data. The business development data is associated with the business development activity of users in an organization. An interactive display of business development data includes interactive links that allow a user to update the business development data via a remote computer. Requests to update the business development data based on recent business development activity may be initiated from or by the system for individual users or groups of users, for example, via automated messages with interactive links. Progress towards goals and metrics may be used to trigger requests for updates.

### CROSS REFERENCE TO RELATED APPLICATION

This application claims priority to, and any other benefit of, U.S. Provisional Patent Application Ser. No. 62/021,943, filed on Jul. 8, 2014 and entitled Business Development System and Method (Attorney Docket No. 00706/05468), which is hereby fully incorporated by reference.

### COPYRIGHT NOTICE

A portion of the disclosure of this patent document contains material which is subject to copyright protection. The copyright owner has no objection to the facsimile reproduction by any one of the patent disclosure, as it appears in the Patent and Trademark Office patent files or records, but otherwise reserves all copyright rights whatsoever.

### BACKGROUND OF THE INVENTION

Various organizations, including, for example, law firms, accounting firms, sales offices, various service organizations, etc., engage in business development activities. These business development activities are generally actions, efforts, etc. that attempt to sustain or generate business activity for the organization. For example, a law firm may want to develop more business from an existing client and/or generate new business from a potential client by increasing awareness of the firm's capabilities to the existing and/or potential clients. Business development activities may be performed by various individuals within or associated with the organization. These activities may be assigned to one or more individuals and/or individuals may volunteer. Activities may also be part of an overall business development plan for an individual and/or a group of individuals that may be measured and/or tracked over a period of time.

### SUMMARY

In one embodiment, a system for managing business development activity includes a server having a memory comprising business development data and user data, wherein business development data is associated with the business development activity of users in an organization, logic generating an interactive display of business development data on one or more remote computers, wherein the interactive display includes at least one interactive link, logic reading a request to update the business development data by a user from the one or more remote computers, wherein the user requests the update via an interactive link, and logic providing a field to enter or reading the business development data on the interactive display, and logic storing the entered business development data, wherein the stored business development data is available for initiating an update request to the user from the system.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to example the embodiments of this invention.

FIG. 1 is an exemplary overall system diagram in accordance with one embodiment.

FIG. 2 is an exemplary block diagram of one embodiment of the business development activity logic.

FIG. 3 is an exemplary system diagram in accordance with one embodiment.

FIG. 4 is an exemplary flowchart of one embodiment of business development activity data update logic.

FIG. 5 is an exemplary flowchart of one embodiment of business plan update logic.

FIG. 6 is an exemplary flowchart of one embodiment of user business development activity summary logic.

FIG. 7 is an exemplary flowchart of one embodiment of group business development activity summary logic.

FIG. 8 is an exemplary flowchart of one embodiment of business development activity query initiation logic.

FIG. 9 is an exemplary flowchart of one embodiment of business development activity message logic.

FIG. 10 is an exemplary flowchart of another embodiment of business development activity query initiation logic.

FIG. 11 is an exemplary flowchart of one embodiment of business development activity message logic for a query.

FIG. 12 is an exemplary flowchart of one embodiment of search logic.

FIG. 13A is an exemplary illustration of one embodiment of a business development activity summary display.

FIG. 13B is another exemplary illustration of one embodiment of a business development activity summary display.

FIG. 13C is another exemplary illustration of one embodiment of a business development activity summary display.

FIG. 13D is another exemplary illustration of one embodiment of a business development activity summary display.

FIG. 14 is an exemplary illustration of one embodiment of a business plan attachment display.

FIG. 15 is an exemplary illustration of one embodiment of a business development activity update display.

FIG. 16 is an exemplary illustration of one embodiment of a business development activity submission form display.

FIG. 17 is an exemplary illustration of another embodiment of a business development activity submission form display.

FIG. 18 is an exemplary illustration of another embodiment of a business development activity submission form display.

FIG. 19 is an exemplary illustration of another embodiment of a business development activity submission form display.

FIG. 20 is an exemplary illustration of another embodiment of a business development activity submission form display.

FIG. 21 is an exemplary illustration of another embodiment of a business development activity submission form display.

FIG. 22 is an exemplary illustration of one embodiment of a bio text display.

FIG. 23A is an exemplary illustration of one embodiment of a time entry summary chart display.

FIG. 23B is an exemplary illustration of another embodiment of a time entry summary chart display.

FIG. 23C is an exemplary illustration of another embodiment of a time entry summary chart display.

FIG. 23D is an exemplary illustration of another embodiment of a time entry summary chart display.

FIG. 24 is an exemplary illustration of one embodiment of an event detail display.

FIG. 25 is an exemplary illustration of one embodiment of a news/blog post detail display.

FIG. 26 is an exemplary illustration of one embodiment of a user listing display.

FIG. 27 is an exemplary illustration of one embodiment of an email notification display.

FIG. 28 is an exemplary illustration of one embodiment of a business development activity update display associated with an email notification.

FIG. 29 is an exemplary illustration of one embodiment of a notification administrator page display.

FIG. 30 is an exemplary illustration of one embodiment of a user report display.

### DESCRIPTION

The following includes definitions of exemplary terms used throughout the disclosure. Both singular and plural forms of all terms fall within each meaning:

“Software,” as used herein, includes but is not limited to one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“Logic,” synonymous with “circuit,” as used herein, includes but is not limited to hardware, firmware, software and/or combinations of each to perform a function(s) or an action(s). For example, based on a desired application or needs, logic may include a software controlled microprocessor, discrete logic such as an application specific integrated circuit (ASIC), or other programmed logic device. Logic may also be fully embodied as software.

“Browser,” as used herein, includes but is not limited to any computer program used for accessing sites, data or information on a network (as the World Wide Web) including, for example, toolbars and application programs. The browser may be configured to access, download, and/or execute logic and/or software located remote computers. Examples of browsers include Internet Explorer by Microsoft Corp. of Redmond, Wash. and Safari by Apple Corp. of Cupertino, Calif. Other browser programs are also applicable.

While the above exemplary definitions have been provided, it is Applicant's intention that the broadest reasonable interpretation consistent with this specification be used for these and other terms.

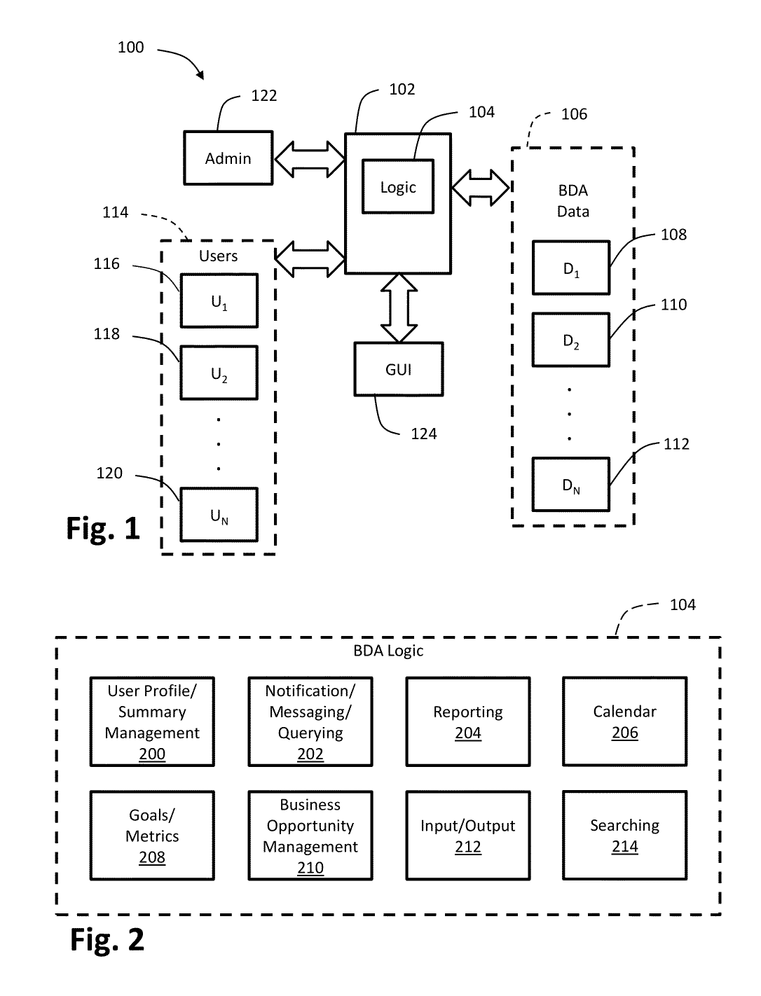

Illustrated in FIG. 1 is an exemplary business development activity (BDA) system 100 in accordance with one embodiment of the present invention. System 100 includes, for example, a server 102 that interacts with various users 114, BDA data sources and/or data 106, administration 122, and a graphical user interface (GUI) 124. One or more GUIs 124 may be associated with the various users 114 and administrators 122. Server 102 includes BDA logic 104, which will be described in more detail hereinafter. Server 102 receives inputs and sends outputs to users 114, admins 122, and BDA data stores/sources 106 via a networked environment. The network environment may be wide, local, wireless, or wired. In one embodiment, users 114 interact with BDA logic 104 through an Internet protocol. BDA data 106 regarding business development activities are transferred back and forth between users 114 and server 102 over the network. Users 114 can include a plurality of users U₁-U_{N}, shown as 116-120, respectively. Users 114 can use any one of a plurality of forms of client-type devices to interact with server 102. These include Web browsers, desktop computers, laptop computers, tablet computers, smart phones, and other similar type devices.

Server 102 also reads and stores BDA data 106. BDA data 106 can include any data associated with a business development activity. It can include, for example, the type of activity, the user(s) associated with the activity, the client(s) associated with the activity, the name of the activity, the time of the activity, activity goals/metrics, the cost of the activity, the requester of the activity, etc. BDA data 106 may be actual or planned. This list is not intended to be exhaustive but merely illustrative of data 106 that can be associated with business development activities. For example, BDA data 106 can include data regarding a plurality of activities from various sources D₁-D_{N}, shown as 108-112, respectively. Business development activities can include various events (e.g., sporting events, plays and shows, concerts and orchestras, and any other event(s) suitable for client and/or business development and/or entertainment), time spent developing individual and/or firm competencies, speaking events, writing papers/articles, presenting at continuing education classes or seminars, participating in boards and/or committees, presenting proposals or pitches to potential clients, news/blog mentions, etc. This list is not intended to be exhaustive but merely illustrative of activities that can be associated with BDA data 106, as described in more detail below.

Server 102 also interacts with one or administrators 122. Server 102 sends and receives information from admin 122. In one embodiment, admin 122 provides the inputs necessary for BDA management, including planning, goal-setting, tracking, forecasting, reporting, etc. In other embodiments, admin 122 provides for other administrative functions such as, for example, the input of user 114 and business development activities and their management. In another embodiment, admin 122 provides for the modification of BDA data, user data, group data, trigger data, custom report data, and/or other data from an administrative perspective. In another embodiment, admin 122 provides for interfacing with other networked systems, database management, input/output management with other data sources/systems, custom report management, and/or other management functions from an administrative perspective.

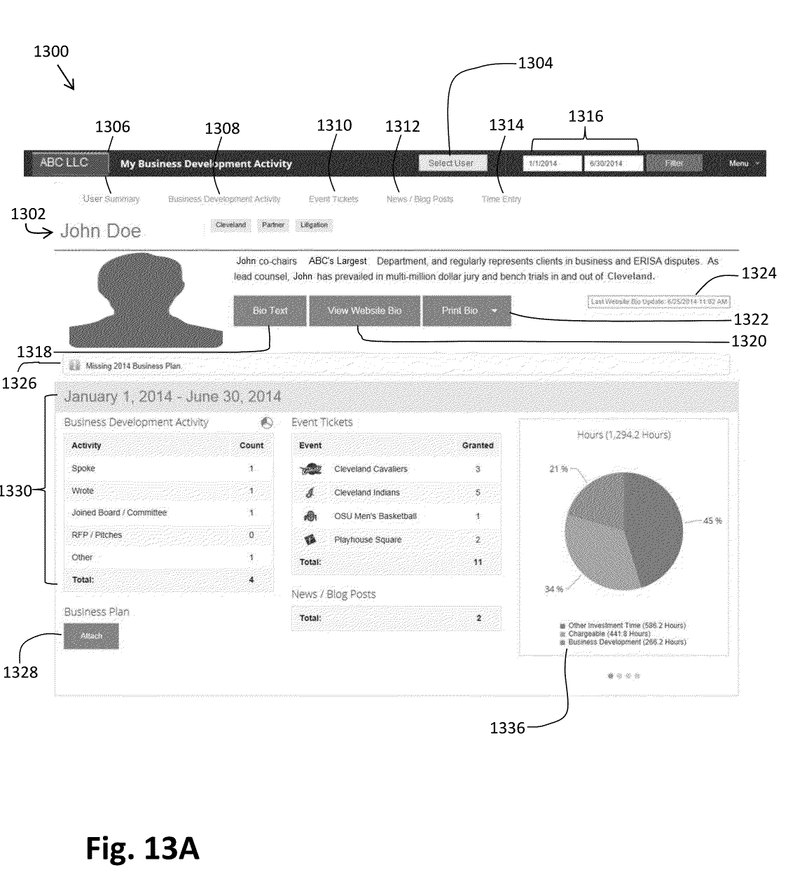

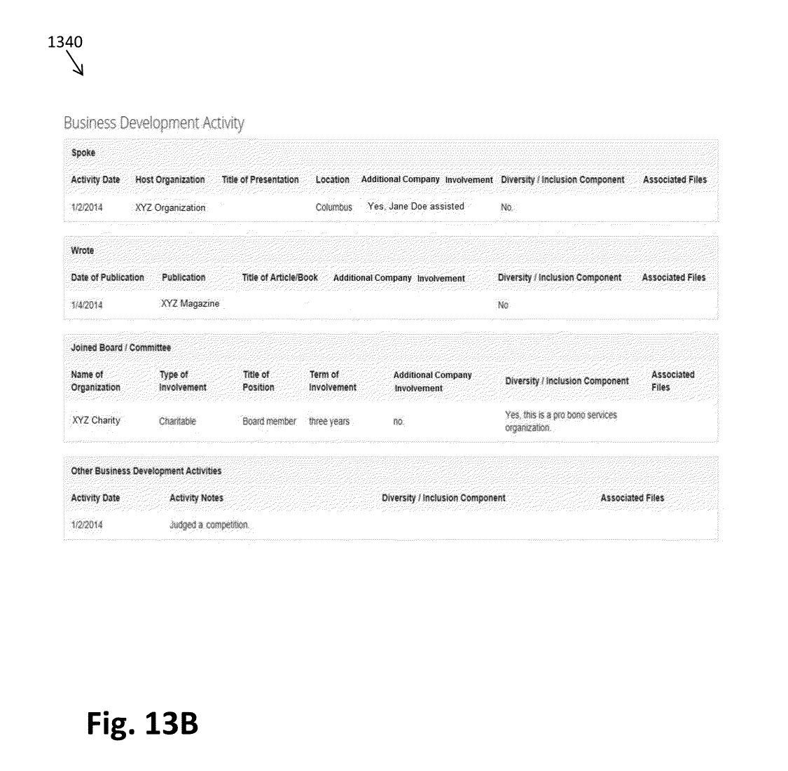

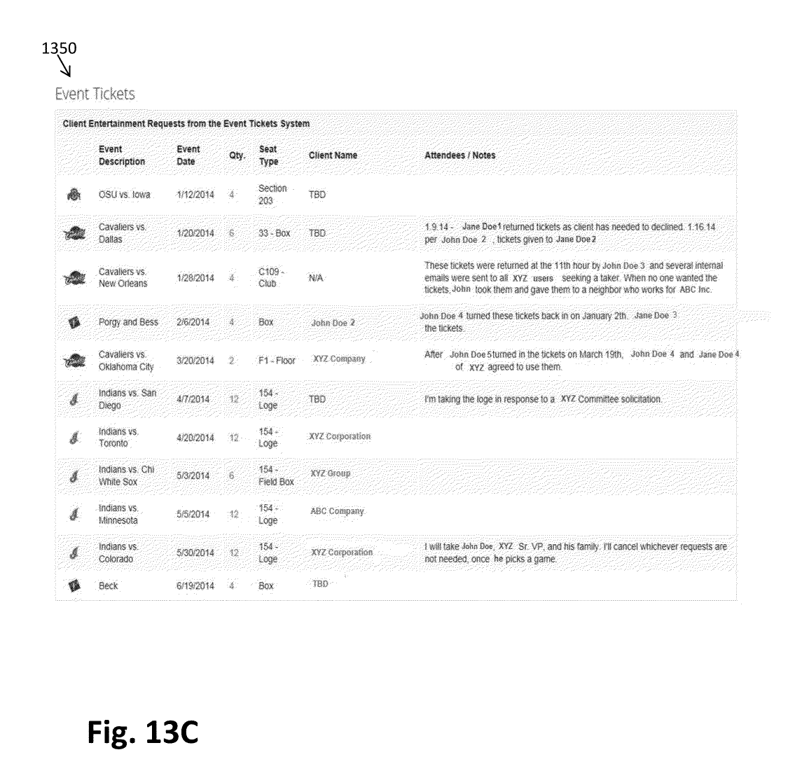

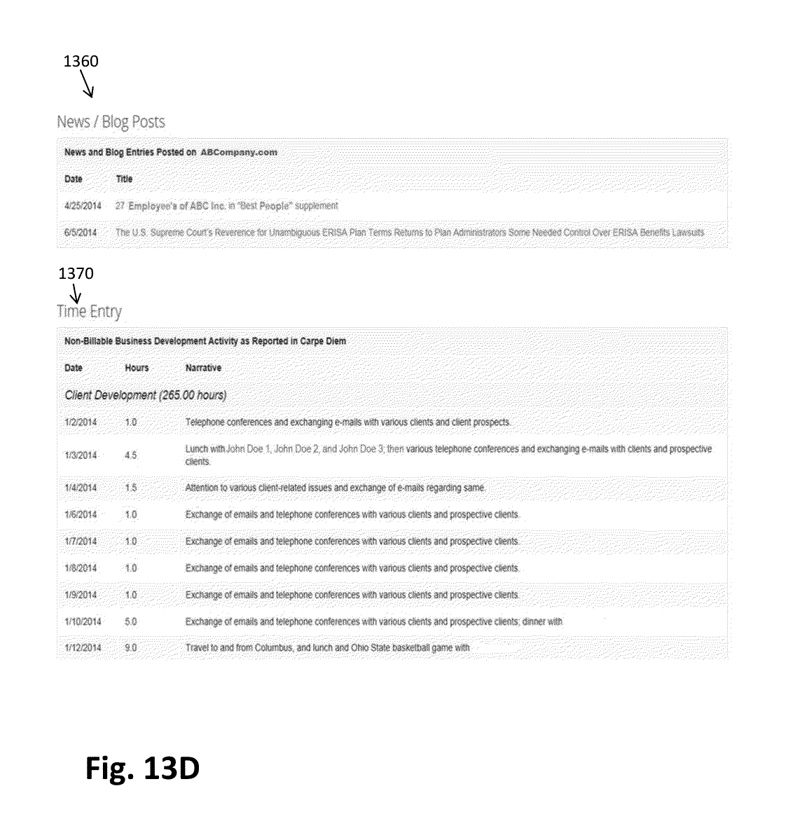

The GUI(s) 124 associated with the various users 114 and administrators 122 are used to input, output, display, and manage various data and features of the BDA system 100, including the BDA data 106. The GUI 124 allows for interaction via, for example, displayed links (e.g., bookmarks, bookmarklets, hyperlinks (including, but not limited to, text and graphics (images, video, charts, etc.)), scripts, etc.) with the BDA system 100 to support the various features and capabilities of the BDA system 100, as described in more detail below. Various examples of these types of links are included in the exemplary screenshots shown in FIGS. 13-30. Server 102 (and logic 104) generate the described displays, links, and interactions.

Referring now to FIG. 2, one embodiment of BDA logic 104 is illustrated. BDA logic 104 includes, for example, user profile/summary management logic 200, notification/messaging/querying logic 202, reporting logic 204, calendar logic 206, goals/metrics logic 208, business opportunity management logic 210, input/output management logic 212, and/or searching logic 214. In other embodiments, addition or fewer logic modules may be present. In other embodiments, one or more modules may be combined or divided. In yet other embodiments, BDA logic 104 includes user 114 and/or admin 122 creatable or customizable modules suited to various other features.

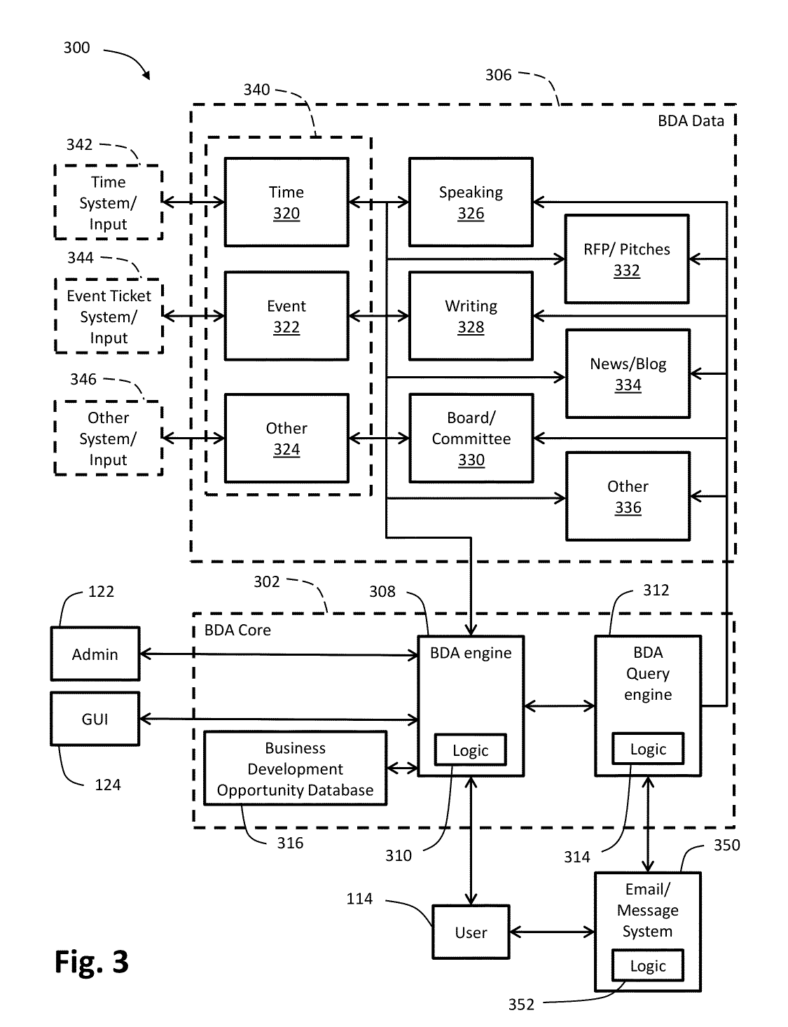

Referring to FIG. 3, an exemplary BDA system 300 in accordance with another embodiment of the present invention is shown. BDA system 300 may be implemented by system 100 of FIG. 1. System 300 includes, for example, a BDA core 302, which may include a server. The exemplary BDA core 302 can interact with various users 114, BDA data sources and/or data 306, administration 122, and GUI 124. The BDA core 302 includes BDA engine 308 and BDA engine logic 310, which can include all or portions of one or more of the logic 104 modules, such as, for example, user profile/summary management logic 200, reporting logic 204, calendar logic 206, goals/metrics logic 208, business opportunity management logic 210, input/output management logic 212, searching logic 214, and/or other logic. The BDA core 302 also includes BDA query engine 312 and BDA query engine logic 314, which can include all or portions of one or more of the logic 104 modules, such as, for example, notification/messaging/querying logic 202, calendar logic 206, goals/metrics logic 208, input/output management logic 212, and/or other logic. The BDA core 302 may also include a business development opportunity database 316, which can receive and store data associated with business development opportunities envisioned by one or more users 114 or admin 122.

BDA engine 308 can receive inputs and send outputs to users 114 and admin 122 via a networked environment, including via GUI(s) 124 and the exemplary links created thereby and described herein. BDA data 306 regarding business development activities are transferred back and forth between users 114/admin 122 and BDA engine 308 over the network. The BDA data 306 can include any data associated with a business development activity, including the data described above in association with BDA data 106. For example, BDA data 306 can include time 320, (e.g., time spent developing individual and/or firm competencies), various events 322 (e.g., sporting events, plays and shows, concerts and orchestras, and any other event(s) suitable for client and/or business development and/or entertainment), speaking events 326 (e.g., presenting at continuing education classes or seminars), writing events 328 (e.g., papers/articles), participating in boards and/or committees 330, presenting/preparing proposals or pitches to potential clients 332, news/blog mentions/posts 334, charitable/community involvement, etc. This list is not intended to be exhaustive but merely illustrative of activities that can be associated with BDA data 306. Data from other business development activities may be included in 324 and 336.

Some BDA data 306 may be data 340 that originate from other data sources, such as, for example, time 320, event 322, and other 324 data. In particular, for example, time data 320 may originate from a time management system 342 that tracks users' time entries, including categories that include business development activities. In another example, event data 322 may originate from an event ticket system 344 that tracks users' event participation, including categories that include business development activities. Other data 324 may originate from other external systems 346, including, for example, other user tracking systems, business development opportunity/activity/participation systems or databases, etc. Data 340 may be pushed and/or pulled in real time, in near real time, and/or per a schedule based on various data requests.

The BDA engine 308 can access the BDA data 306 to support the various features and functions of the BDA system 300. For example, the BDA engine 308 supports data entry, data review, data management (including, e.g., planning, goal-setting, tracking, forecasting, reporting, etc.), data requests (or triggers), etc. In one embodiment, for example, the BDA query engine 312 may receive a trigger to initiate a data request to one or more users 114. The data request may be associated with one or more BDA data 306, including, for example, requests for updated data regarding speaking events 326, writing events 328, participating in boards and/or committees 330, presenting/preparing proposals or pitches 332, news/blog mentions/posts 334, charitable/community involvement, etc. In response to the trigger, the BDA query engine 312 can initiate sending an email or message, for example, via an email/messaging system 350, to the target user(s) 114. In one embodiment, the email/messaging system 350 may include logic 352 specifically for supporting these queries. In response to a query, a user 114 may provide data into a BDA data 306 entry form having, for example, links (e.g., hyperlinks), input text boxes, radial selection buttons, etc. provided with the email/message. In this embodiment, the email/messaging system 350 and BDA query engine 312 can route the business development data entered by the user to the BDA data 306. In another embodiment, the user 114 may access the BDA system 300 via the BDA engine 308 and a GUI 124 to provide the requested BDA data 306 via similar input mechanisms.

In other embodiments, the BDA engine 308 and BDA query engine 312 are combined in the BDA core 302, including as part of server 102. In another embodiment, the BDA data 306 and business development opportunity database 316 may be combined into one or more data store(s). In various embodiments, logic and data may be stored in the same system, including, for example, on one or more servers.

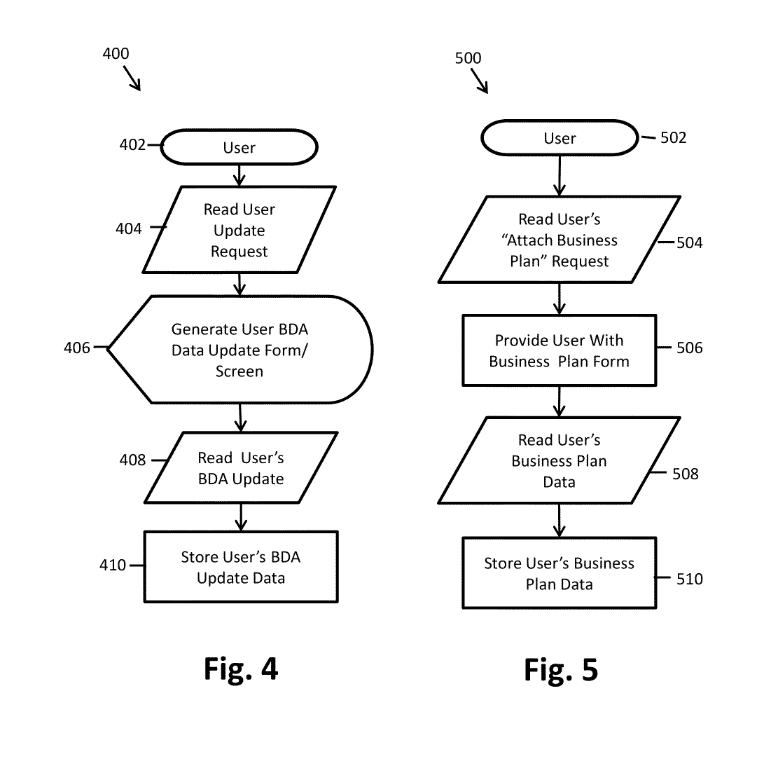

Illustrated in FIGS. 4-12 are exemplary methodology/logic for managing BDA data and information and can be implemented via, for example, logic 104 (FIG. 1) or other described logic herein. As illustrated, the blocks represent functions, actions and/or events performed therein. It will be appreciated that electronic and software applications involve dynamic and flexible processes such that the illustrated blocks can be performed in other sequences different than the one shown, including in parallel. It will also be appreciated by one of ordinary skill in the art that elements embodied as software may be implemented using various programming approaches such as machine language, procedural, object oriented or artificial intelligence techniques. It will further be appreciated that, if desired and appropriate, some or all of the software can be embodied as part of a device's operating system.

In the figures, the elements denote “processing blocks” and represent computer software instructions or groups of instructions. The diamond shaped elements denote “decision blocks” and represent computer software instructions or groups of instructions which affect the execution of the computer software instructions represented by the processing blocks. Other shapes indicate, for example, processing, reading, inputting, storing and/or displaying blocks. Alternatively, these blocks represent steps performed by functionally equivalent circuits such as a digital signal processor circuit or an application specific integrated circuit (ASIC). The flow diagram does not depict syntax of any particular programming language. Rather, the flow diagram illustrates the functional information one skilled in the art may use to fabricate circuits or to generate computer software to perform the processing of the system. It should be noted that many routine program elements, such as initialization of loops and variables and the use of temporary variables are not shown.

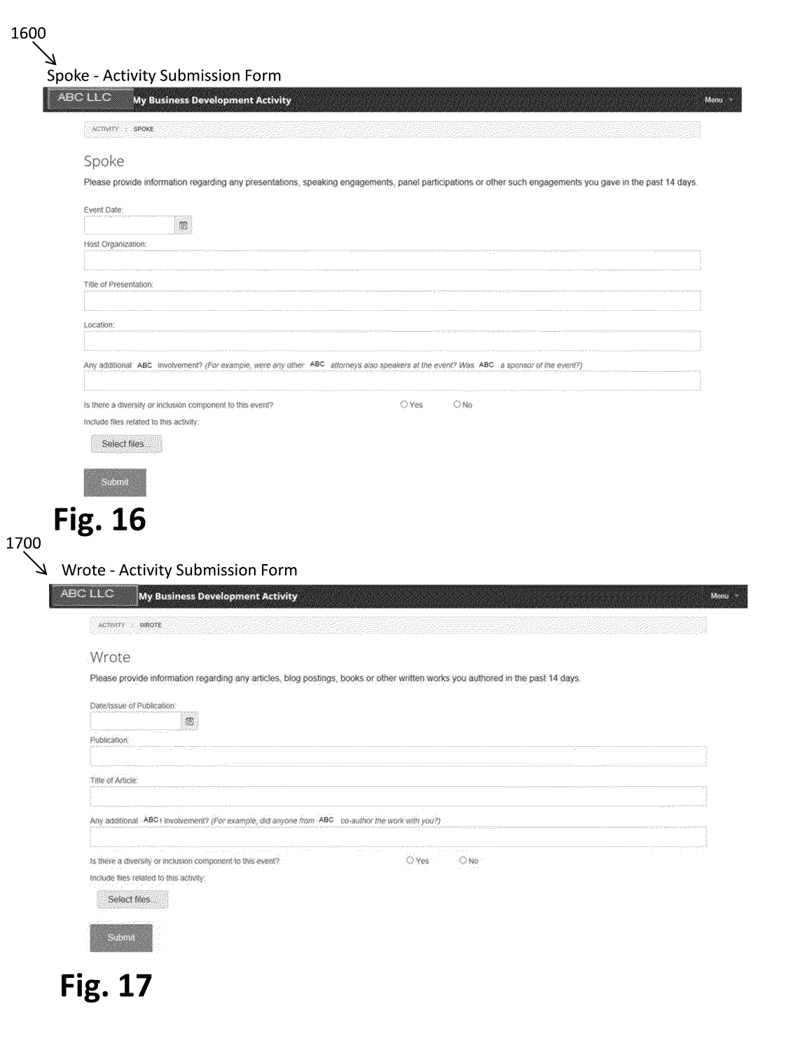

Illustrated in FIG. 4 is one embodiment of a flowchart showing logic 400 for updating a user's BDA data. In this embodiment, one or more users can access a server-based BDA system (e.g., BDA system 100, 300) at block 402. Upon accessing the BDA system, the user may be presented with their BDA summary page, which may contain links to various described interactive functions. One example of a BDA summary page 1300 is shown in FIG. 13. In block 404, the logic reads a request by the user to update BDA data (e.g., BDA data 106, 306). In one embodiment, the user's BDA summary page can include a BDA or business plan update button (or, e.g., hyperlink), similar to button 1328 shown in FIG. 13. In response to the request at block 404, the logic can generate a user BDA data update field, selection, form, screen, etc. containing, for example, links, hyperlinks, and/or scripts for the entry of data. One example of a user BDA data update form/screen 1500 is shown in FIG. 15. Examples of specific types of BDA data submission forms are shown in FIGS. 16-21. In block 408, the logic reads BDA data entered by the user. FIG. 15 also shows exemplary BDA data 1520 entered by a user. In block 410, the logic stores the BDA data entered by the user.

In another embodiment, FIG. 5 shows a flowchart with logic 500 for uploading a user's business plan, which may be associated with BDA data. In this embodiment, one or more users can access a server-based BDA system at block 502. Upon accessing the BDA system, the user may be presented with their BDA summary page (e.g., BDA summary page 1300 is shown in FIG. 13). In block 504, the logic reads a request by the user to upload or attach their business plan. As described, the request can be made by the user via, for example, a link, hyperlink, and/or script, associated with buttons or other graphics or text. In one embodiment, the user's BDA summary page can include a business plan update button 1328, as shown in FIG. 13. In response to the request at block 504, the logic can provide the user with a business plan form/screen or display a window for browsing to an existing business plan file. In block 508, the logic reads data entered by the user or captures/copies the existing business plan file identified by the user. In block 510, the logic stores the BDA data or file from the user.

In some embodiments, a user can enter BDA data according to process 400 and enter a business plan form according to process 500. For example, in one embodiment, a business plan may include general objectives for a user and BDA data may include specific activities to reach those objectives. In these embodiments, a user's BDA summary page can include more than one buttons to initiate processes 400, 500, or other similar processes.

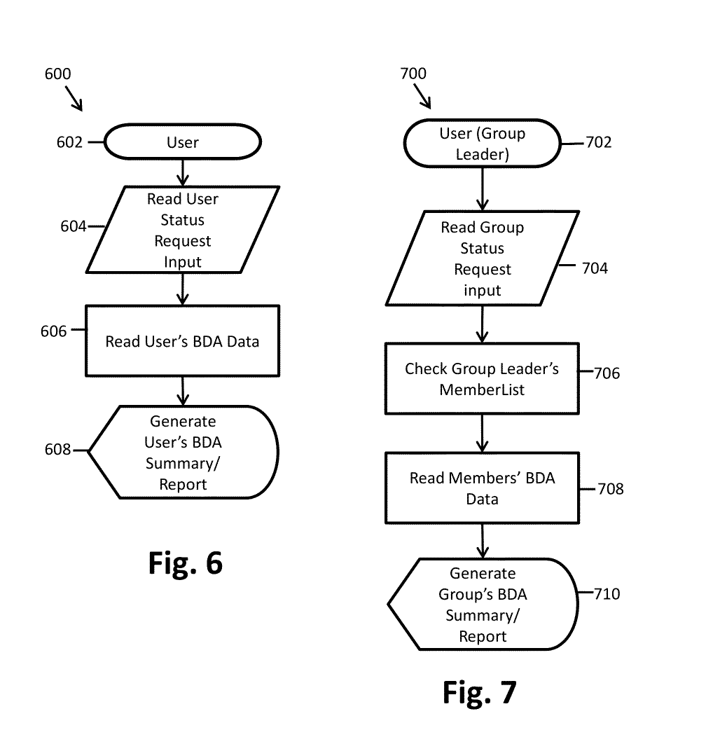

Illustrated in FIG. 6 is one embodiment of a flowchart showing logic 600 for reviewing a user's BDA data. In this embodiment, one or more users can access a server-based BDA system at block 602. Upon accessing the BDA system, the user may request to review their BDA summary page at block 604, for example, via a link. At block 606, the logic reads the user's BDA data. At block 608, the logic generates the user's BDA summary page. As mentioned above, one example of a BDA summary page 1300 is shown in FIG. 13.

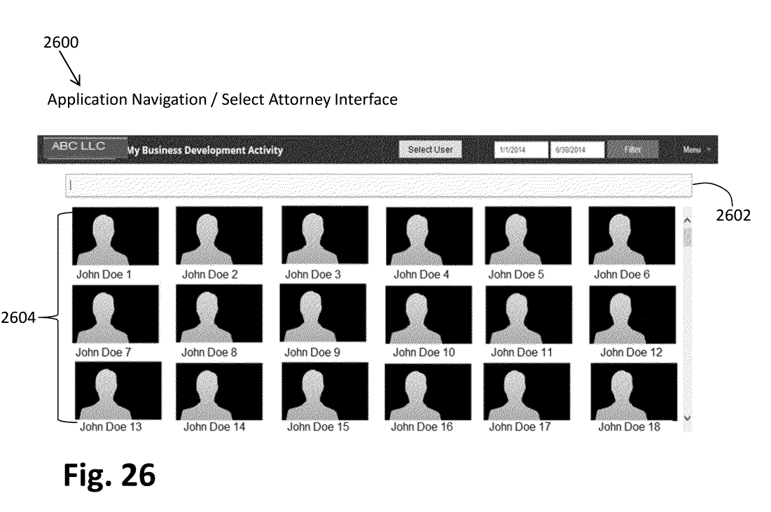

Referring now to FIG. 7, one embodiment of a flowchart showing logic 700 for reviewing a group of users' BDA data is shown. In this embodiment, a user that is a group leader may access a server-based BDA system at block 702. In some embodiments, the log-in credentials or profile of a user will determine what features, including groups, the user has access to. Upon accessing the BDA system, the user (group leader) may request to review the BDA summary page for some or all of the members in the group at block 704. At block 706, the logic determines the member list associated with the group leader's selection from a database of members. One example of a group's member list page 2600 is shown in FIG. 26. The group leader may select one or more members, or the entire group. At block 708, the system reads each of the members' BDA data. At block 710, the logic generates the group's (list of member's) BDA summary page. The members' BDA data may be presented in one or more formats, for example, the group BDA data may be aggregated, listed separately by member, listed by sub-groups of member, or combinations thereof. Also, the members may be displayed or presented through links, hyperlinks, or scripts that cause more detailed information about each member to be displayed.

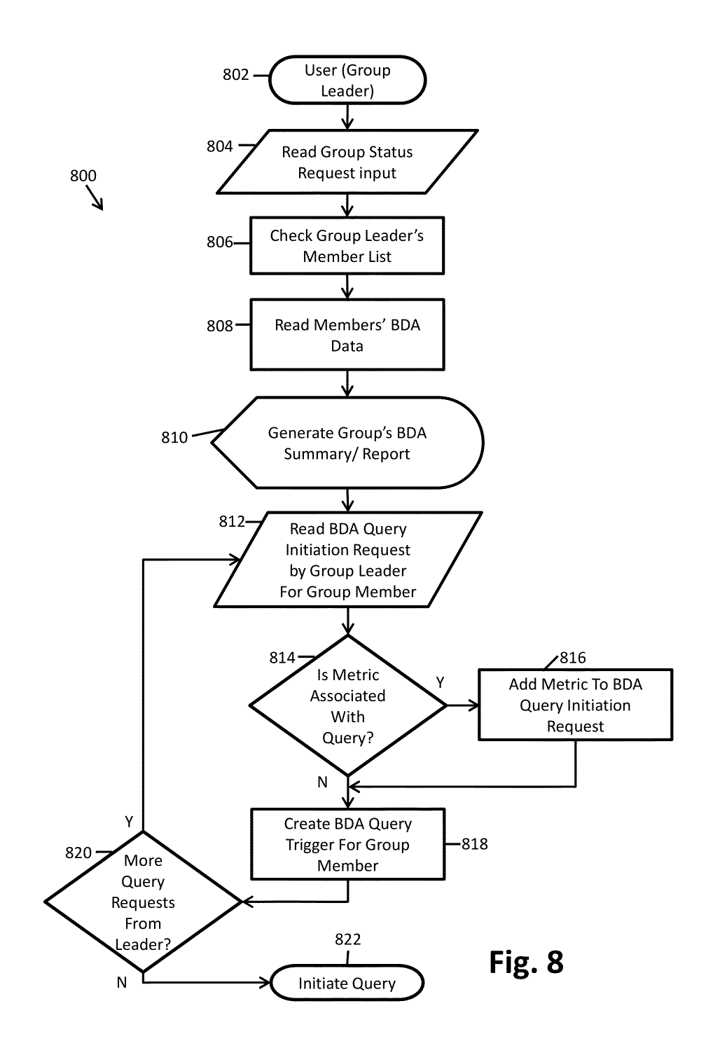

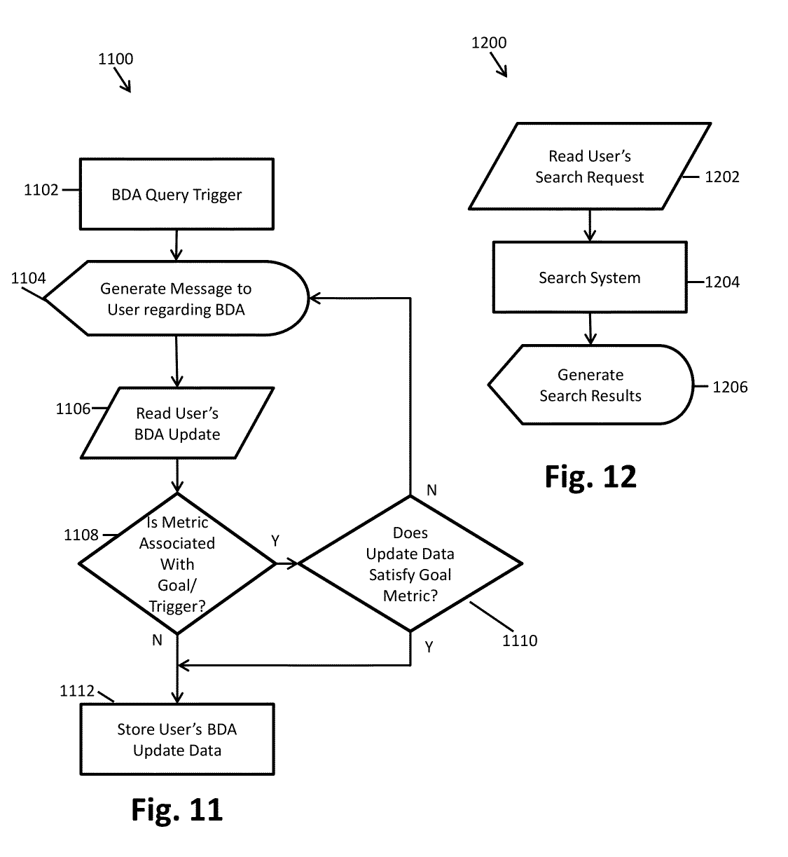

FIG. 8 shows one embodiment of a flowchart showing logic 800 for initiating a BDA query to one or more members of a group. In this embodiment, a user that is a group leader may access a server-based BDA system at block 802. In some embodiments, the log-in credentials of a user will determine what features, including groups and the ability to initiate BDA queries, the user has access to. Upon accessing the BDA system, the user (group leader) may request to review the BDA summary page for one, some, or all of the members in the group at block 804. At block 806, the logic determines the member list associated with the group leader's selection through a database. The group leader may select one or more members, or the entire group, for example, via links, hyperlinks and/or scripts. At block 808, the system reads each of the members' BDA data. At block 810, the logic generates the group's (list of member's) BDA summary page. The members' BDA data may be presented in one or more formats and include links, hyperlinks and/or scripts to member data. For example, the group BDA data may be aggregated, listed separately by member, listed by sub-groups of member, or combinations thereof. After reviewing the members' BDA data, the group leader may initiate a request for a query to one or more members at block 812 via link, hyperlink, and/or script, or other similar mechanism. The query may be for a variety of reasons, such as, for example, a request for an update to the member's BDA data by the member, to notify the member of a new BDA goal, to notify the member of the member's progress towards a BDA goal, etc. At block 814, the logic determines if there is a metric associated with the query. For example, certain BDAs may have metrics if the system already has a stored metric associated with the BDA, the group leader adds a new or revised metric to a BDA goal, the logic associates a default metric to a BDA goal, etc. In some embodiments, there are no metrics associated with a BDA. If there is a metric associated with the query, at block 816, the metric is added to the query initiation request. At block 818, a BDA query trigger is created for the group member. At block 820, the logic determines if there are more query requests from the group leader. If yes, the logic returns to block 812 to start creating BDA query triggers for another group member. When all of the BDA query triggers have been created, the logic initiates the query or queries at block 822, as described in process 1100 of FIG. 11.

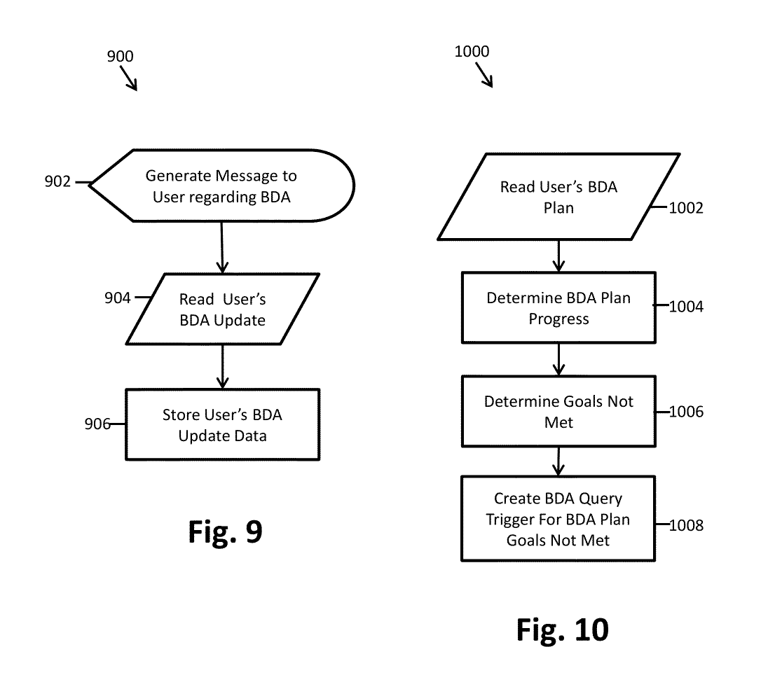

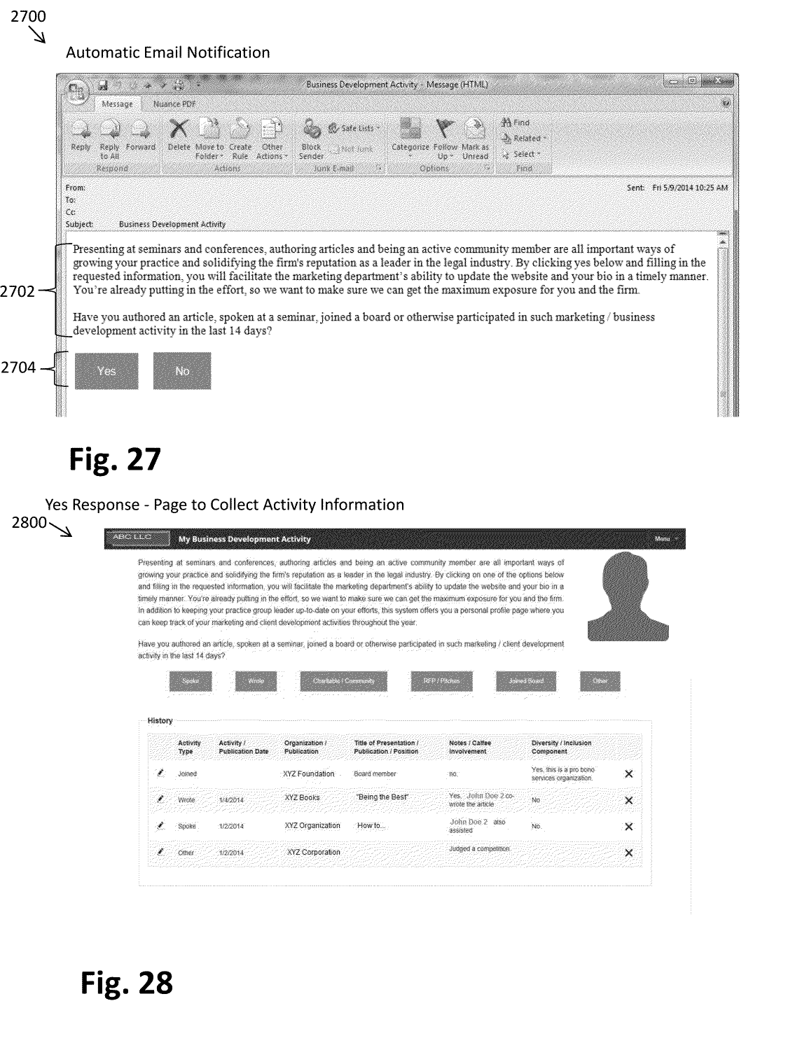

Illustrated in FIG. 9 is one embodiment of a flowchart showing logic 900 for generating a message to a user regarding updates to the user's BDA data. In this embodiment, at block 902, the logic can generate a message to a user requesting that the user update their BDA data. In one embodiment, the logic schedules the message according to a schedule and/or event, such, for example, every two weeks, four weeks after the most recent update, two weeks before a planned BDA goal, three days after a planned activity, etc. One example of an automatic email message/notification 2700 is shown in FIG. 27, which includes buttons (or links, hyperlinks, and/or scripts) 2704 to indicate whether the user has any updated BDA data to submit. For example, in one embodiment, if the user selects the “yes” button 2704 shown in FIG. 27, the logic can present the user with the BDA data update form/screen 2800 shown in FIG. 28, followed by the applicable BDA data submission forms shown in FIGS. 16-21. In block 904, the logic reads BDA data entered by the user via the links, hyperlinks, scripts or other similar mechanisms. FIG. 28 also shows exemplary BDA data entered by a user. In block 906, the logic stores the BDA data entered by the user.

FIG. 10 shows one embodiment of a flowchart showing logic 1000 for initiating a BDA query to a user based on the user's BDA plan. In this embodiment, the logic reads a user's BDA plan at block 1002. At block 1004, the logic then determines the progress of the user, for example, by comparing the user's BDA plan to the user's current BDA data. At block 1006, the logic can determine if a BDA goal has not been met, a goal is approaching a deadline, etc. At block 1008, a BDA query trigger can be created for a BDA goal that has not been met, a goal that is approaching a deadline, etc.

Illustrated in FIG. 11 is one embodiment of a flowchart showing logic 1100 for generating a message having one or more links, hyperlinks, and/or scripts to a user regarding updates to the user's BDA data based on a BDA query trigger. In this embodiment, at block 1102 the logic receives a BDA query trigger for a user, for example, from process 800 or 1000, shown in FIGS. 8 and 10, respectively. At block 1104, the logic can generate a message to a user requesting that the user update their BDA data. One example of an automatic email message/notification 2700 is shown in FIG. 27, which includes buttons 2704 to indicate whether the user has any updated BDA data to submit. For example, in one embodiment, if the user selects the “yes” button 2704 shown in FIG. 27, the logic can present the user with a BDA data update form/screen 2800 shown in FIG. 28, followed by the applicable BDA data entry forms shown in FIGS. 16-21. In block 1106, the logic reads BDA data entered by the user. FIG. 28 also shows exemplary BDA data entered by a user. In block 1108, the logic determines if there is a metric associated with a BDA goal or the trigger. If yes, the logic can compare the BDA update data with the goal metric to determine if the updated BDA data satisfies the goal metric. If the updated BDA data does not satisfy the goal metric, the logic can generate a message to the user that the updated BDA data does not satisfy the goal metric at block 1104, providing the user another opportunity to provide updated BDA data. If the updated BDA data does satisfy the goal metric or if there is not a metric associated with a BDA goal or the trigger, the process proceeds to block 1112, where the logic stores the BDA data entered by the user.

FIG. 12 shows one embodiment of a flowchart showing logic 1200 for searching a BDA system. In this embodiment, the logic reads a user's search request at block 1202. At block 1204, the logic then searches the BDA system, including, for example, BDA databases, databases associated with the BDA system, other users' BDA data, etc., for results matching the user's search criterion. Various types of search techniques may be utilized, including plain English, Boolean, keyword, fuzzy, etc. At block 1206, the logic generates search results for the user. Searching may be utilized for a variety of reasons, including, for example, to determine if a potential BDA activity has already been started by another user or overlaps with another user's planned BDA activity, ideas for potential BDAs, to find users associated with a particular client, business group, etc. For example, one user may plan to make a pitch to a potential client, but would like to search to see if the potential client is already a client, another user has already made contact with the client or plans to do so, etc. This data may be included in areas searchable by the system, including, for example, a current client database, a potential business development opportunity database, another user's BDA data, etc.

FIGS. 13-30 show various displays and screenshots that may be displayed using the GUIs 124 mentioned above and include one or more links, hyperlinks, scripts and/or other similar mechanisms. Navigation, selections, data entry, etc., may be via a keyboard, microphone, mouse, and/or other device associated with the GUI 124. Data and information displayed on the displays and screenshots may be retrieved or derived from a BDA system and/or a BDA process, including any of those mentioned above.

FIGS. 13A-13D illustrate one embodiment of a user's BDA summary page 1300. In one embodiment, FIGS. 13A-13D are displayed together; in another embodiment, a user can step through FIGS. 13A-13D using page navigation controls. The first section of the BDA summary page 1300, shown in FIG. 13A, includes a summary of the user 1302, including a picture of the user and a brief description, and an option to select another user 1304. In one embodiment, as shown in FIG. 26, a user selection screen 2600, including, for example, a search bar 2602 and/or a list of users 2604 may be provided in a new window.

Referring back to FIG. 13, the top of page 1300 includes selections that navigate to others sections of the page 1300: user summary 1306 (FIG. 13A); business development activity 1308 (FIG. 13B); event tickets 1310 (FIG. 13C); news/blog posts 1312 (FIG. 13D); and time entry 1314 (FIG. 13D). In one embodiment, the information displayed in these sections of page 1300 includes data from a BDA system, such as, for example, BDA system 300 including BDA data 306.

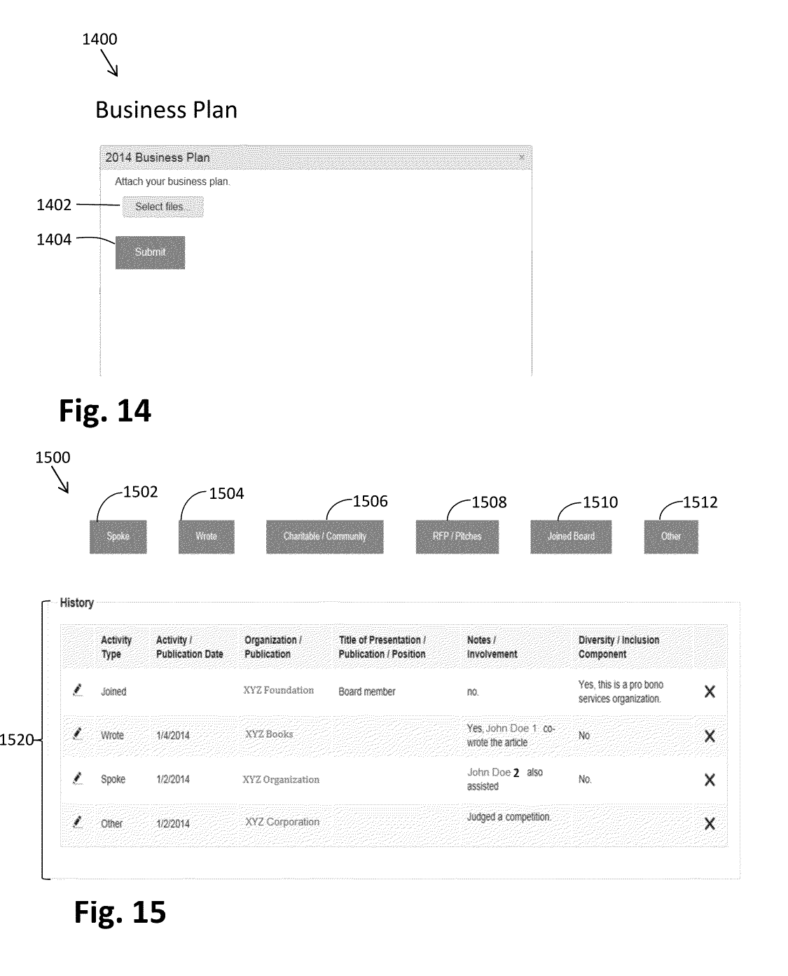

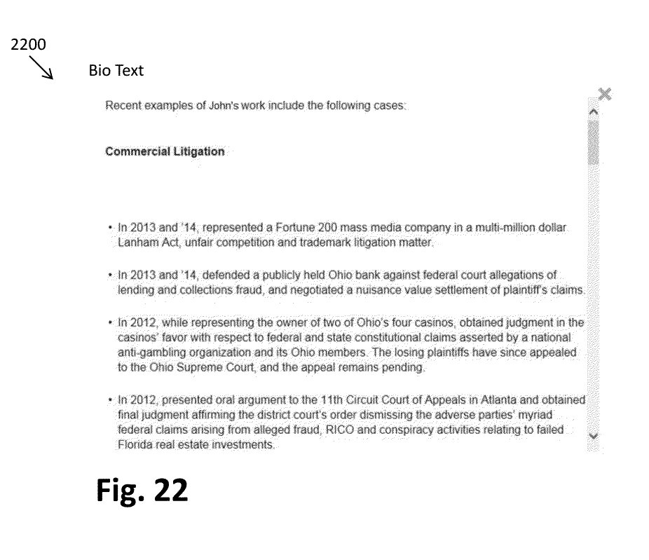

The top of the page 1300 also includes an option to select a date range 1316 to filter the data/information shown on the page 1300. The first section of the BDA summary page 1300 also includes other selections: bio text 1318 opens a window (or navigates to a page) with the user's bio text, for example, bio text 2200 shown in FIG. 22; view website bio 1320 opens a link to the user's website bio page; and print bio 1320 prints the user's bio or opens a window with print options, including, for example, a print dialog box. The page 1300 may also include a notification of the date of the last website bio update 1324. The page 1300 may also include a notification of the status of the user's business plan 1326 and a selection to update or attach a business plan 1328. FIG. 14 shows an exemplary window 1400 for attaching a business plan, including the capabilities to browse 1402 and submit 1404. Referring back to FIG. 13, page 1300 may also include a BDA summary section 1330 that summarizes the BDA and other information shown in the other sections of the page 1300, including, for example, a summary of the BDA and other information shown in FIGS. 13B-13D.

FIG. 13B illustrates one embodiment of a user's exemplary business development activity 1340. For example, in this embodiment, details regarding when the user spoke, wrote, or joined a board/committee, and other BDAs are listed. FIG. 13C illustrates one embodiment of a user's exemplary event/ticket information 1350. For example, in this embodiment, details regarding when the user attended or arranged for others to attend an event are listed. FIG. 13D illustrates one embodiment of a user's news/blog posts 1360 and one embodiment of a user's time entries 1370. For example, in this embodiment, details regarding when the user was mentioned in the news or a blog are listed, as well as business development activity from a time entry system. In one embodiment, the time entry 1370 and event ticket 1350 information originate from outside systems, such as, for example, time system 342 and/or event ticket system 344, as shown in FIG. 3.

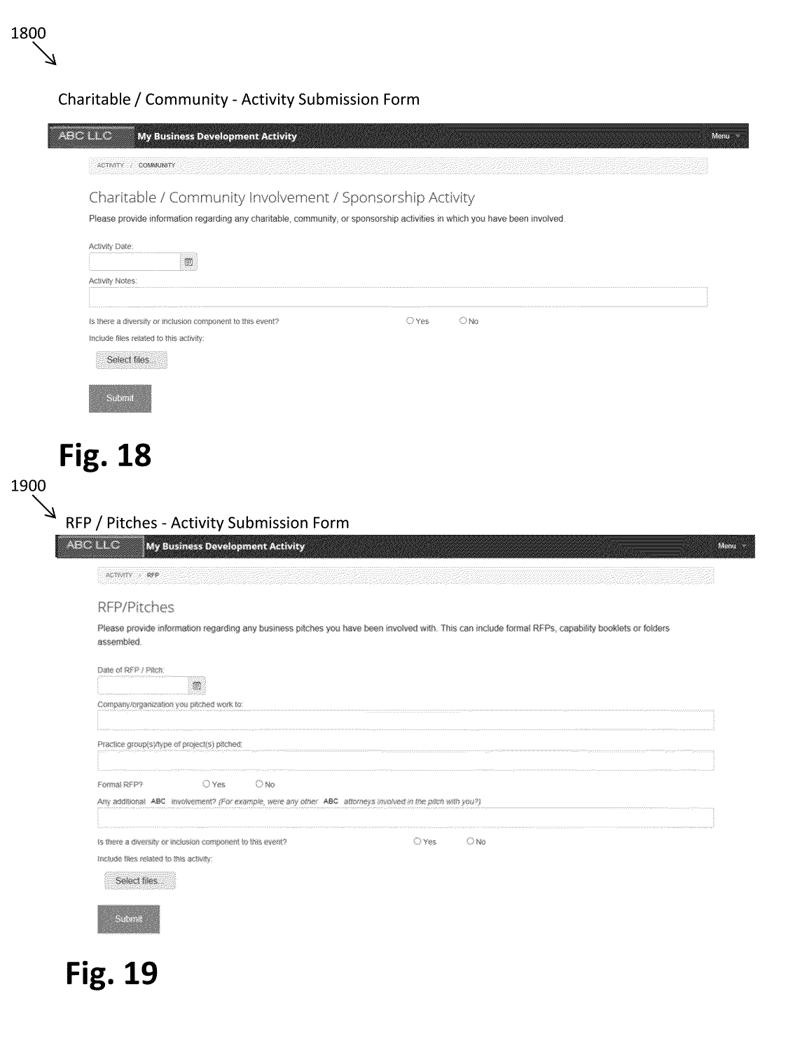

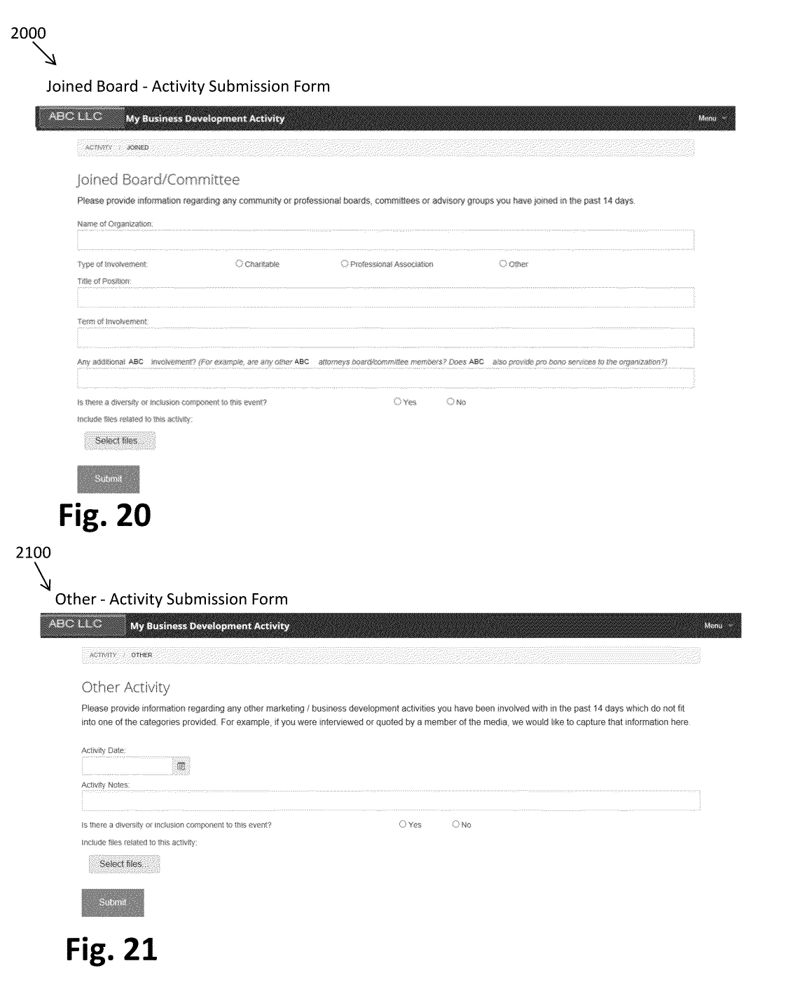

The BDAs that are included in the BDA summary section 1330 and BDA section 1340 are derived from BDA information associated with the user, including the BDA information submitted by the user using BDA submission forms. Referring now to FIG. 15, an exemplary user BDA data update form/screen 1500 is illustrated. The top of the page 1500 includes selections that allow the user to enter the details of their BDA into a submission form: spoke 1502 (see exemplary submission form 1600 shown in FIG. 16); wrote 1504 (see exemplary submission form 1700 shown in FIG. 17); charitable/community 1506 (see exemplary submission form 1800 shown in FIG. 18); request for proposal (RFP)/pitches 1508 (see exemplary submission form 1900 shown in FIG. 19); joined board 1510 (see exemplary submission form 2000 shown in FIG. 20); and other 1512 (see exemplary submission form 2100 shown in FIG. 21). The exemplary BDA submission forms shown in FIGS. 16-21 include fields that allow the user to enter the details of the BDA and to select and submit files associated with the BDA. FIG. 15 also shows exemplary BDA data 1520 entered by a user. FIG. 28 and page 2800 allow for similar BDA data entry in response to an email message and/or query.

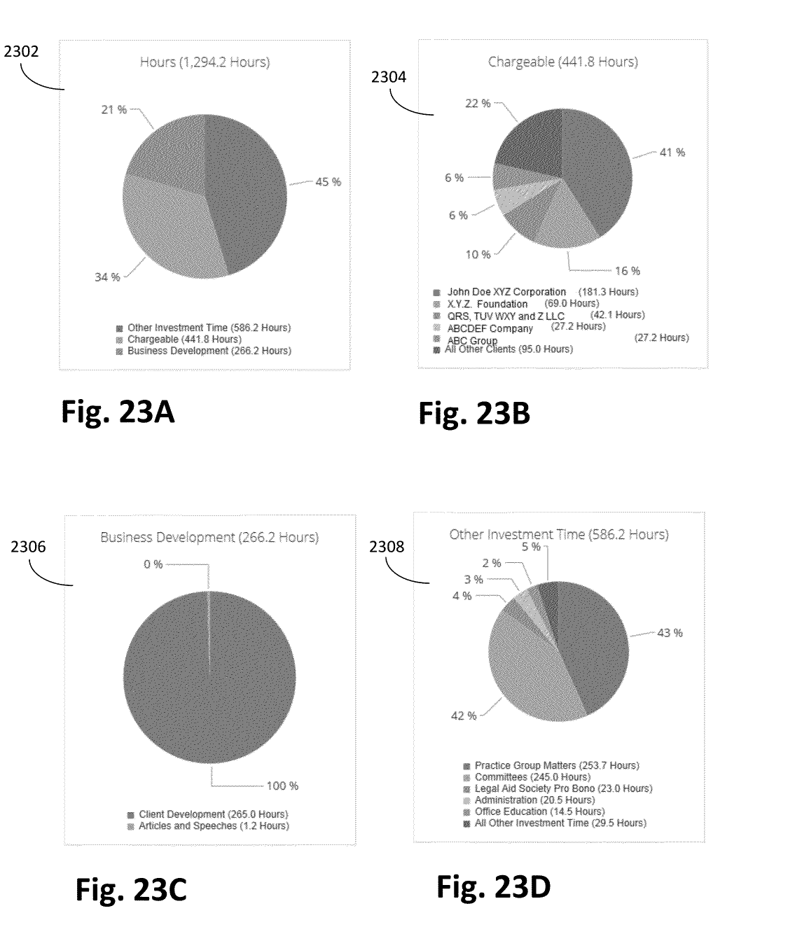

Referring back to FIG. 13, the BDA summary section 1330 also includes a chart 1336 summarizing the time entry information listed in 1370. For example, in this embodiment, an initial chart 2302, as shown in FIG. 23A, shows a summary of the hours from the time entries, including, for example, a breakdown of the user's time, such as, for example, time attributed to chargeable time, business development time, and other investment time. By selecting the chart (e.g., by hovering over the chart and selecting with a mouse of the GUI 124), the display can proceed through a sequence of charts shown in FIGS. 23A-23D. For example, in this embodiment, another chart 2304, as shown in FIG. 23B, shows a breakdown of the user's chargeable time. Another chart 2306, as shown in FIG. 23C, shows a breakdown of the user's business development time. Yet another chart 2308, as shown in FIG. 23C, shows a breakdown of the user's other investment time. It should be appreciated that in other embodiments, any number of displays, charts, tables, diagrams, etc., can be used to provide a summary of the user's time and/or other information associated with their BDAs.

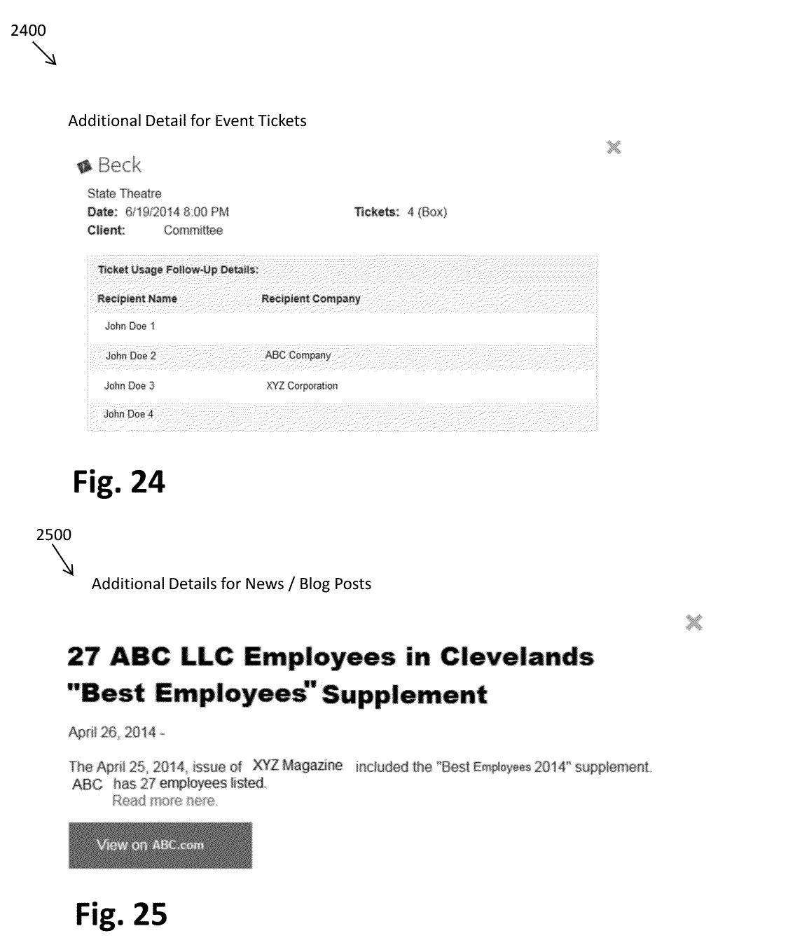

Various additional information and details may be available by selecting various items listed on a user's BDA summary page 1300. For example, in one embodiment, as shown in FIG. 24, after selecting the last event ticket entry from the event/ticket information 1350 screen, a window with additional information regarding that event 2400 is shown to the user. In another embodiment, as shown in FIG. 25, after selecting the first news entry from the news/blog post information 1370 screen, a window with additional information regarding that event 2500 is shown to the user.

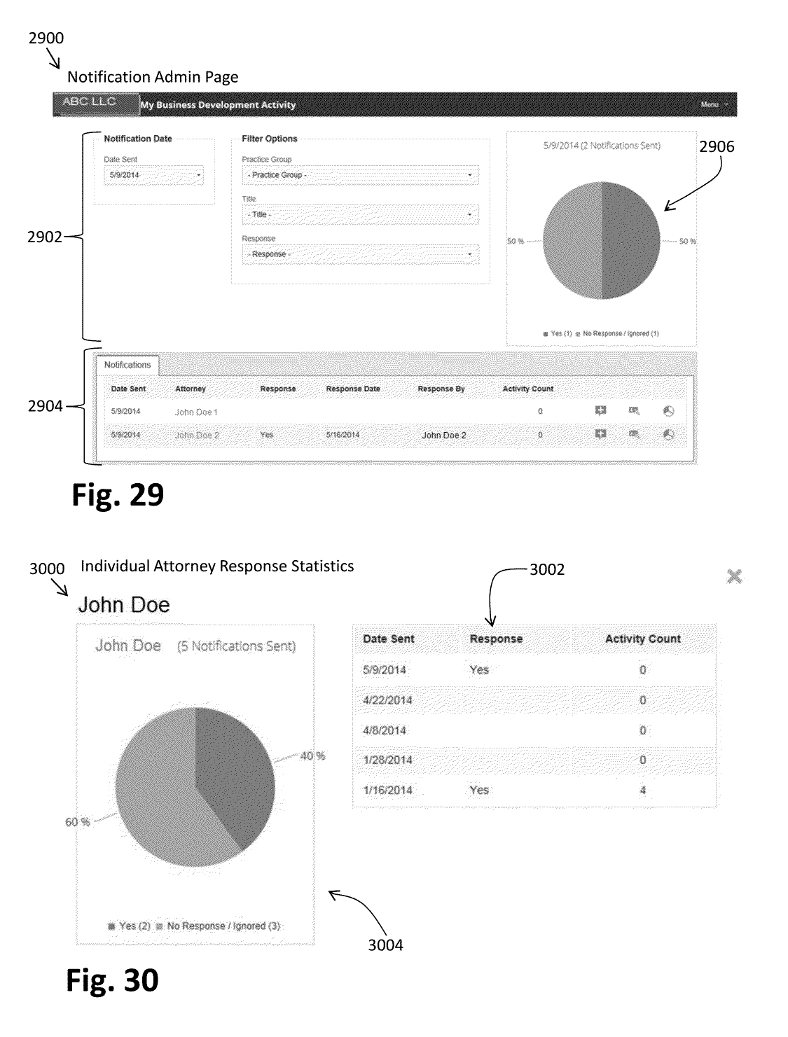

Various reports may also be created, displayed, messaged, printed, etc. FIG. 29 illustrates one embodiment of an exemplary notification administrator page 2900. Admin page 2900 may have access limited to system administrators, group leaders, etc., that have responsibility for other users, reporting needs, etc. Admin page 2900 allows the user (admin) to create a report showing the status of responses to notifications according to the parameters selected in section 2902. In this embodiment, the results 2904 are shown on the bottom of page 2900, showing which users have responded to the designated notifications established by the parameters in 2902. In this embodiment, a results chart 2906 is also displayed. Various additional information and details may be available by selecting various items listed in the results section 2904. For example, in one embodiment, as shown in FIG. 30, after selecting the last user from the results section 2904, a window with additional information regarding that user 3000 is shown to the admin. In this example, the selected user's notification and response history is shown in section 3002. In this embodiment, a history chart 3004 is also displayed.

It should be appreciated that in other embodiments, any number of reports can be created, displayed, messaged, printed, etc., to provide summary and/or status information associated with various users, clients, BDAs, or any other searchable parameters.

The system and method of the present invention can be implemented on a variety of platforms including, for example, networked computer systems and stand-alone computer systems. Additionally, the logic and databases shown and described herein preferably reside in or on a computer readable medium such as, for example, a Read-Only Memory (ROM), Random-Access Memory (RAM), programmable read-only memory (PROM), electrically programmable read-only memory (EPROM), electrically erasable programmable read-only memory (EEPROM), magnetic disk or tape, and optically readable mediums including CD-ROM and DVD-ROM. Still further, the processes and logic described herein can be merged into one large process flow or divided into many sub-process flows. The order in which the process flows herein have been described is not critical and can be rearranged while still accomplishing the same results. Indeed, the process flows described herein may be rearranged, consolidated, and/or re-organized in their implementation as warranted or desired.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. For example, the displays and inputs of the present invention can be in any form suitable for obtaining the requested information. Furthermore, in other embodiments, the displays, logic, data, and inputs do not need to have the exact form, number or type as described herein, but can include less than that described herein. Alternatively, additional displays, logic, data and inputs can also be utilized that are consistent with managing a plurality of events. Therefore, the invention, in its broader aspects, is not limited to the specific details, the representative apparatus, and illustrative examples shown and described. Accordingly, departures may be made from such details without departing from the spirit or scope of the applicant's general inventive concept.

Therefore, the invention, in its broader aspects, is not limited to the specific details, the representative apparatus, and illustrative examples shown and described. Accordingly, departures may be made from such details without departing from the spirit or scope of the applicant's general inventive concept.

1-20. (canceled)

21. A system for managing business development activity comprising:
a server having a memory comprising business development data, wherein the business development data includes one or more business development activities of each of a plurality of users in an organization;
logic for determining a first interactive display of at least part of the business development data, wherein the first interactive display includes at least one interactive link;
logic for transmitting the first interactive display to one or more remote computers;
logic for receiving an update request, from one or more of the remote computers, to update the business development data of a requested user of the plurality of users, wherein the update request is initiated in response to a requesting user interacting with at least one of the interactive links;
logic for determining a second interactive display, the second interactive display including a field actionable to submit updated business development data;
logic for transmitting the second interactive display to one or more of the remote computers; and
logic for receiving and storing updated business development data in response to the requested user interacting with the field;
wherein the updated business development data is available for determining an update request message to provide to the requested user.

22. The system of claim 21, wherein the requesting user and the requested user are the same user of the plurality of users.

23. The system of claim 21, wherein the requesting user and the requested user are distinct users of the plurality of users.

24. The system of claim 21, wherein the business development data comprises at least one of time data and event data.

25. The system of claim 21, wherein the update request comprises a request by the requested user to upload a business plan; and wherein the field is a business plan form that is actionable by the requested user to submit the business plan.

26. The system of claim 21, further comprising:
logic for receiving a request to review the business development activity of the requested user from the one or more remote computers, wherein the request to review is transmitted in response to the requesting user interacting with a second interactive link;
logic for identifying the business development data associated with the requested user; and
logic for transmitting a business development activity summary page based on the business development data associated with the requested user.

27. The system of claim 21, further comprising:
logic for receiving, from one or more of the remote computers, a request to review the business development activity associated a group of users, wherein the review request is transmitted in response to the requesting user interacting with a second interactive link;
logic for identifying a plurality of group users of the plurality of the users associated with the group based on one or more characteristics associated with the group and one or more characteristics associated with each of the group users;
logic for identifying the business development data associated with each group user;
logic for determining a group business development activity summary page based on the identified business development data associated with each group user; and
logic for transmitting the group business activity summary page to one or more of the remote computers.

28. The system of claim 27, wherein the requesting user is a group leader, and wherein one or more of the characteristics associated with the group are determined based on a profile of the group leader.

29. The system of claim 27, further comprising:
logic for generating a display with a list of users of the plurality of users; and
logic for receiving a selection of users from the list by the requesting user, wherein at least one of the characteristics of the selected users is selection by the requesting user, and wherein at least one of the characteristics of the group is an identifier of the requesting user.

30. The system of claim 21, wherein the interactive link comprises a hyperlink.

31. The system of claim 21, wherein the interactive link is associated with a script.

32. The system of claim 21, wherein the interactive link is displayed as a button.

33. A system for managing business development activity comprising:
a server having a memory comprising business development data, wherein business development data includes one or more business development activities of each of a plurality of users in an organization;
logic for generating an electronic message to a user of the plurality of users, wherein the message includes at least one interactive link, and wherein the message is associated with the business development activity of the user;
logic for transmitting the electronic message to the user;
logic for receiving updated business development data of the user from one or more remote computers, wherein the updated business development data is transmitted in response to the user interacting with at least one of the interactive links; and
logic for storing the updated business development data.

34. The system of claim 33, further comprising
logic for determining a schedule for sending the electronic message to the user, wherein the electronic message is automatically sent to the user according to the schedule;
logic for identifying a goal associated with a planned business development activity; and
logic for determining one or more triggers based on the goal; and
logic for associating the one or more triggers with the schedule, wherein the one or more triggers are each a trigger for transmitting the electronic message, and wherein the electronic message includes an indication of the planned business activity.

35. The system of claim 33, further comprising:
logic for identifying a business plan of the user, wherein the business plan includes the business development data associated with the user and a goal associated with the business plan;
logic for determining a progress of the business plan based on the goal; and
logic for determining a trigger for transmitting the electronic message based on the progress, wherein the electronic message is transmitted when one or more conditions of the trigger are satisfied.

36. The system of claim 35, wherein determining the trigger is further based on the goal.

37. The system of claim 33, further comprising:
logic for identifying a related business development activity that is related to the updated business development data, wherein the related business development activity is associated with a metric;
logic for determining if the updated business development data satisfies a goal associated with the related business development activity based on the metric; and
logic generating a second electronic message to the user indicating the goal if the updated business development data does not satisfy the goal.

38. The system of claim 31, further comprising:
logic for receiving, from one or more of the remote computers, a request to review the business development activity associated a group of users, wherein the review request is transmitted in response to the requesting user interacting with a second interactive link;
logic for identifying a plurality of group users of the plurality of the users associated with the group based on one or more characteristics associated with the group and one or more characteristics associated with each of the group users;
logic for identifying the business development data associated with each group user;
logic for determining a group business development activity summary page based on the identified business development data associated with each group user; and
logic for transmitting the group business activity summary page to one or more remote computers;
logic for receiving a request for update to the business development data of one or more users of the group from one or more remote computers, wherein the update request is via a third interactive link; and
logic creating a trigger for the electronic message based on the request.

39. The system of claim 38, further comprising logic for determining a metric associated with the business development activity summary page based on the business development data associated with each group user.

40. A computer-implemented method for managing business development activity, comprising:
identifying business development data, wherein the business development data includes one or more business development activities of each of a plurality of users in an organization;
determining a first interactive display of at least part of the business development data, wherein the first interactive display includes at least one interactive link;
transmitting the first interactive display to one or more remote computers;
receiving an update request, from one or more of the remote computers, to update the business development data of a requested user of the plurality of users, wherein the update request is initiated in response to a requesting user interacting with at least one of the interactive links;
determining a second interactive display, the second interactive display including a field actionable to submit updated business development data;
transmitting the second interactive display to one or more of the remote computers; and
receiving and storing updated business development data in response to the requested user interacting with the field;
wherein the updated business development data is available for determining an update request message to provide to the requested user.
